(19) United States
(12) Patent Application Publication
(10) Pub. No.: US 2019/0229481 A1
(43) Pub. Date: Jul. 25, 2019

(54) ELECTRICAL CONNECTOR HAVING UPPER GROUND CONTACT SOLDERED TO LOWER GROUND CONTACT DURING A MOLDING OPERATION

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: JUN ZHAO, HUAIAN (CN)

(21) Appl. No.: 16/253,123

(22) Filed: Jan. 21, 2019

(30) Foreign Application Priority Data
Jan. 23, 2018 (CN) 201810061714.1

(51) Int. Cl. H01R 43/02; H01R 43/24; H01R 13/6585; H01R 13/6597

(52) U.S. Cl. CPC H01R 43/02; H01R 43/24; H01R 24/60; H01R 13/6597; H01R 13/6585

(57) ABSTRACT

An electrical connector includes: an insulative housing having a base and a tongue; and an upper and a lower rows of contacts secured to the insulative housing and exposed respectively to an upper and a lower faces of the tongue, each row of contacts including a ground contact, each of the ground contact in the upper row and the ground contact in the lower row having an extension, wherein at least one of the extensions of the upper ground contact and the lower ground contact is applied with material tin (Sn), and the material Sn is connected between the extension of the upper ground contact and the extension of the lower ground contact. A related method of making such connector includes melting the material Sn during an over-molding process.

### BACKGROUND OF THE INVENTION

### 1. Field of the Invention

The present invention relates to an electrical connector including an insulative housing retaining two rows of contacts, each row of contacts including a ground contact having a respective extension, wherein the extensions of the upper and lower ground contacts are soldered together, or wherein the electrical connector may include a middle shielding plate between the two rows of contacts and the extension of at least one ground contact is soldered to the middle shielding plate. The present invention also relates to related methods of making such electrical connectors.

### 2. Description of Related Arts

U.S. Pat. No. 9,484,679 discloses an electrical connector, including: an insulative housing having a base and a tongue; and an upper and a lower rows of contacts secured to the insulative housing and exposed respectively to an upper and a lower faces of the tongue, each row of contacts including a ground contact, each of the ground contacts in the upper row and the ground contact in the lower row having an extension at a front end thereof, wherein the extension of the upper ground contact directly abuts the extension of the lower ground contact in a vertical direction, or wherein the electrical connector may include a middle shielding plate between the two rows of contacts and the extensions of the ground contacts directly abut the middle shielding plate.

### SUMMARY OF THE INVENTION

An electrical connector comprises: an insulative housing having a base and a tongue; and an upper and a lower rows of contacts secured to the insulative housing and exposed respectively to an upper and a lower faces of the tongue, each row of contacts including a ground contact, each of the ground contact in the upper row and the ground contact in the lower row having an extension, wherein at least one of the extensions of the upper ground contact and the lower ground contact is applied with material tin (Sn), and the material Sn is connected between the extension of the upper ground contact and the extension of the lower ground contact. A related method of making such connector includes melting the material Sn during an over-molding process.

### BRIEF DESCRIPTION OF THE DRAWING

FIG. 1 is a front and top perspective view of an electrical connector in accordance with a first embodiment of the present invention;

FIG. 2 is a rear and bottom perspective view of the electrical connector;

FIG. 3 is an exploded view of the electrical connector omitting a shielding shell thereof;

FIG. 4 is a view similar to FIG. 3 but from another perspective;

FIG. 5 is a further exploded view of FIG. 3;

FIG. 6 is a view similar to FIG. 5 but from another perspective;

FIG. 7 is a further exploded view of FIG. 5;

FIG. 8 is a cross-sectional view of the electrical connector taken along line A-A in FIG. 1;

FIG. 9 is a view similar to FIG. 8 but showing an electrical connector in accordance with a second embodiment of the present invention;

FIG. 10 is a view similar to FIG. 8 but showing an electrical connector in accordance with a third embodiment of the present invention;

FIG. 11 is a view similar to FIG. 8 but showing an electrical connector in accordance with a fourth embodiment of the present invention;

FIG. 12 is a cross-sectional view of an electrical connector in accordance with a fifth embodiment of the present invention taken along line B-B in FIG. 1;

FIG. 13 is a view similar to FIG. 12 but showing an electrical connector in accordance with a sixth embodiment of the present invention;

FIG. 14 is a view similar to FIG. 12 but showing an electrical connector in accordance with a seventh embodiment of the present invention;

FIG. 15 is a cross-sectional view of an electrical connector in accordance with an eighth embodiment of the present invention taken along line C-C in FIG. 1; and

FIG. 16 is a cross-sectional view of an electrical connector in accordance with a ninth embodiment of the present invention taken along line D-D in FIG. 1.

### DETAILED DESCRIPTION OF THE PREFERRED EMBODIMENT

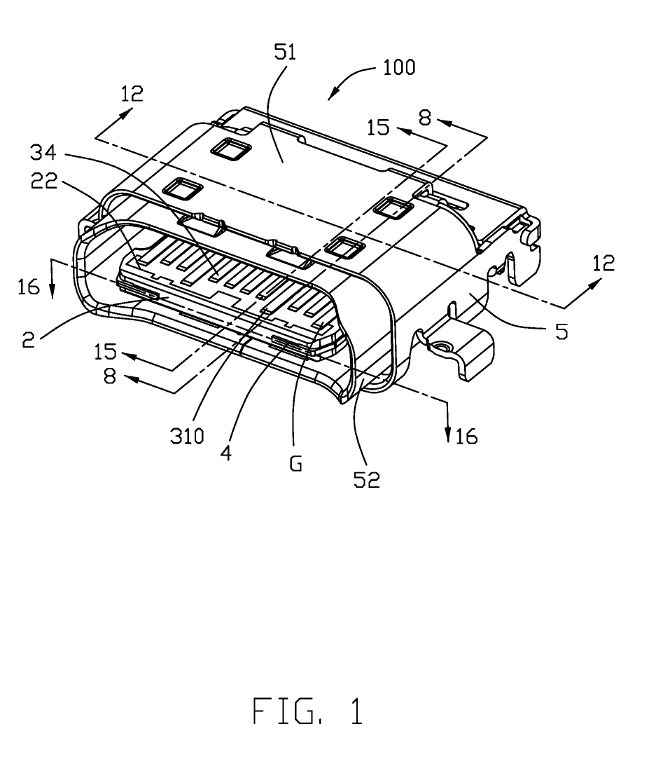

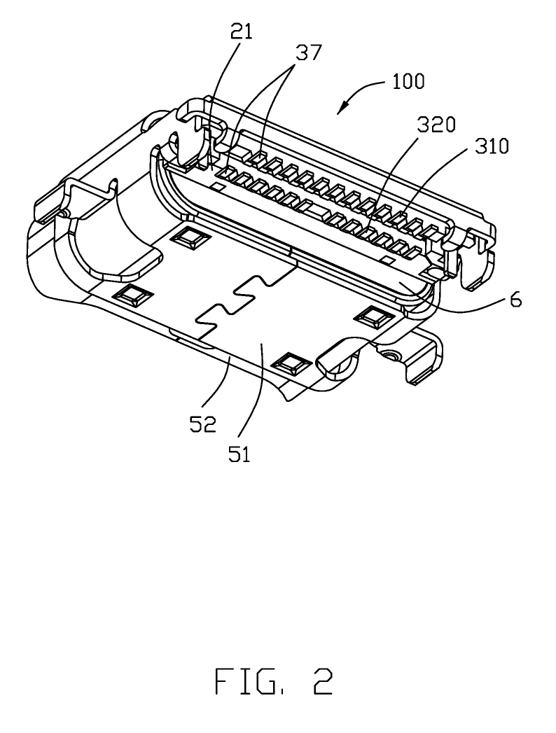

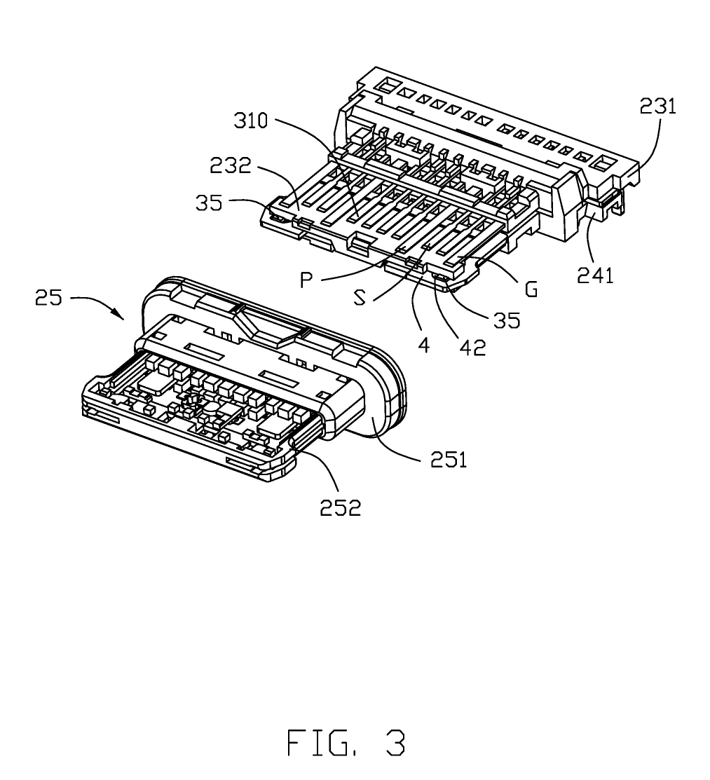

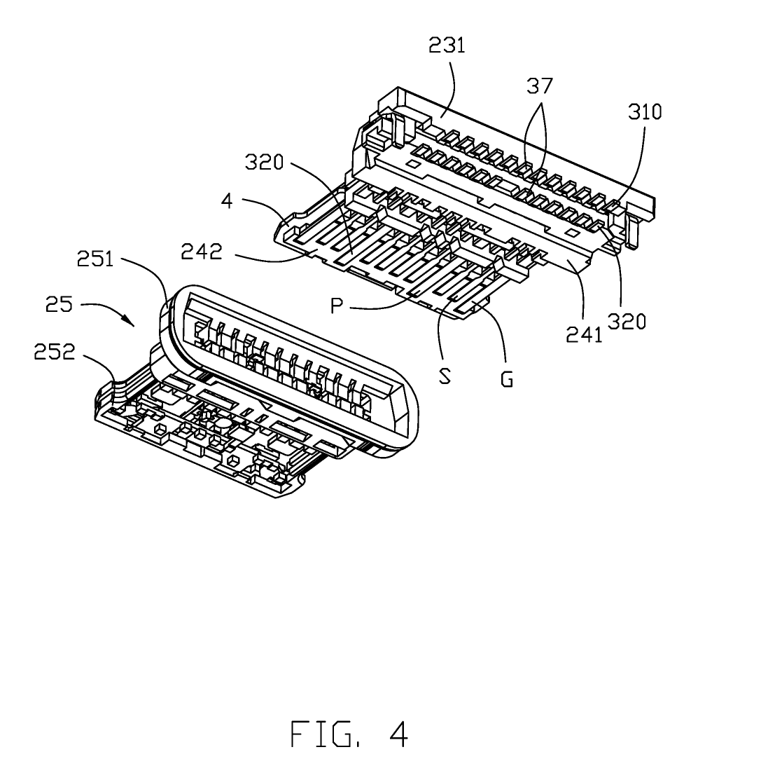

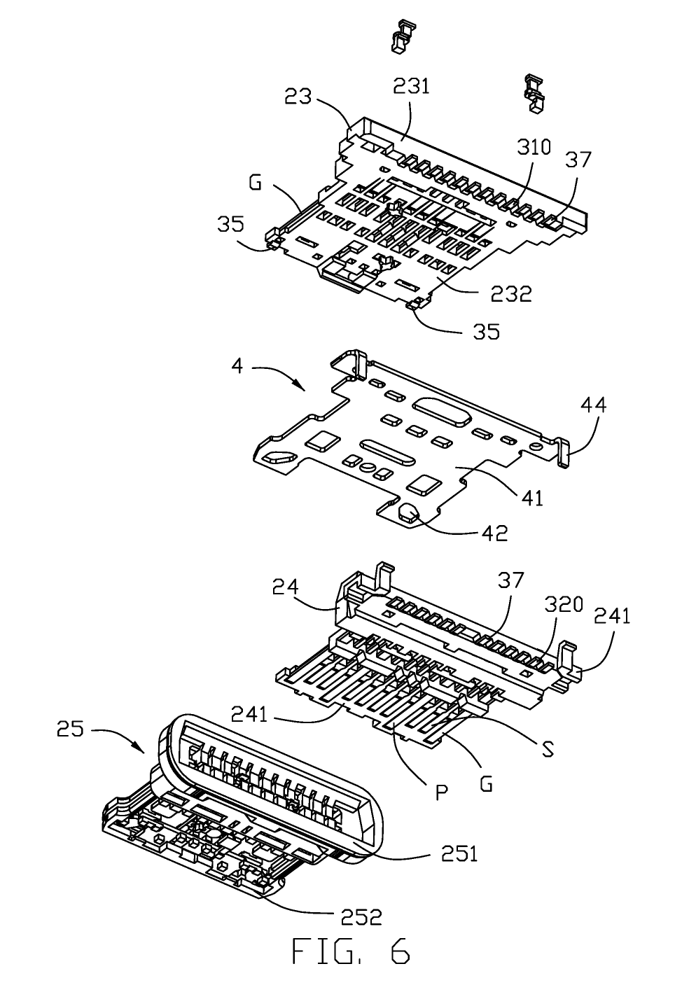

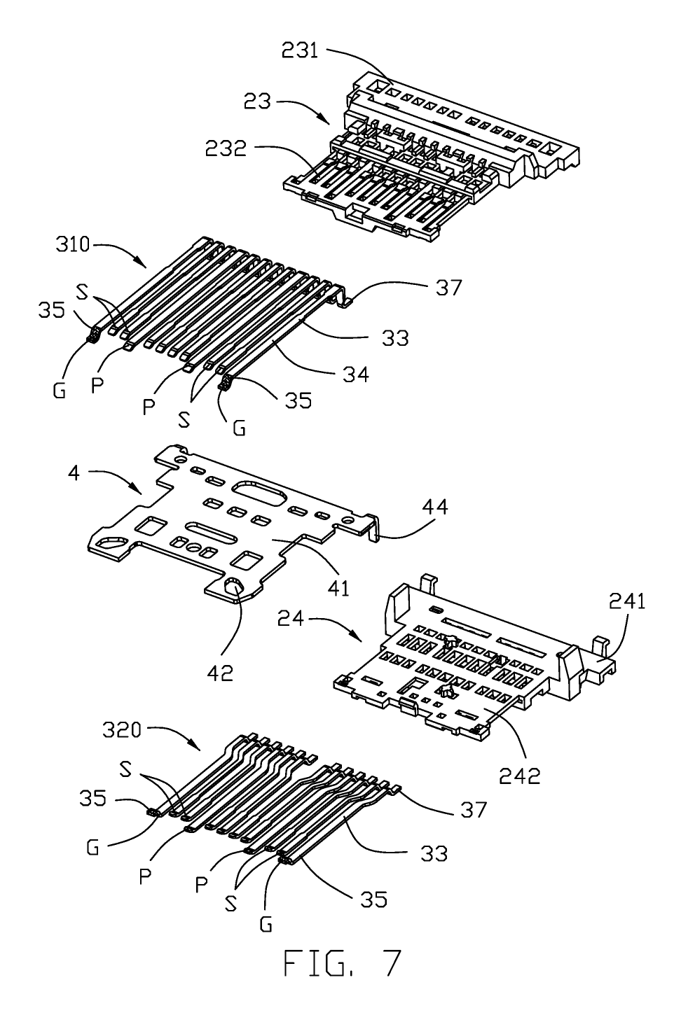

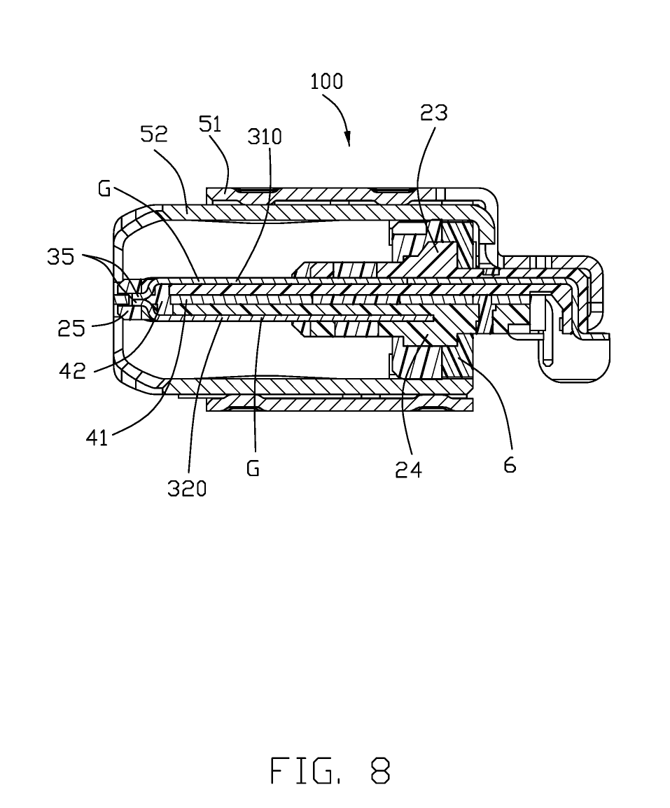

Referring to FIGS. 1-8, an electrical connector 100 of a first embodiment comprises an insulative housing 2 having a base 21 and a tongue 22, and an upper row of contacts 310 and a lower row of contacts 320 secured to the insulative housing 2 and exposed, respectively, to an upper face and a lower face of the tongue 22. The electrical connector 100 may further comprise a middle shielding plate 4 between the upper row of contacts and the lower row of contacts and/or an outer shielding shell 5 enclosing the insulative housing 2. A rear sealing member 6 may also be provided. The insulative housing 2 and the contacts 310 and 320, and optionally the middle shielding plate 4 if present, constitute a contact module.

The insulative housing 2 includes an upper insulator 23, a lower insulator 24, and an over-mold 25. The upper insulator 23 includes a base 231 and a tongue 232. The lower insulator 24 includes a base 241 and a tongue 242. The over-mold 25 includes a base 251 and a tongue 252. The over-mold 25 is molded over the upper and lower insulators 23 and 24 to form the overall insulative housing 2. The bases 231/241/251 constitute an overall base of the insulative housing 2; the tongues 232/242/252 constitute an overall tongue of the insulative housing 2.

The upper row of contacts 310 are insert molded with the upper insulator 23 to constitute an upper contact module unit; the lower row of contacts 320 are insert molded with the lower insulator 24 to constitute a lower contact module unit. Each contact 310 or 320 has a main portion 33 and a soldering tail 37. The main portion 33 includes a contacting portion 34 exposed to the tongue 22 and a securing portion between the contacting portion and the soldering tail. The contacting portion 34 has an extension 35 at a front end thereof embedded in the insulative housing 2. The contacting portions 34 in the upper row and the contacting portions 34 in the lower row are generally reversely-symmetrically arranged, as is well known in this art. Each row of contacts include a pair of outermost ground contacts G, a respective pair of high-speed signal contacts S next to each of the two ground contacts, a respective power contact P inwardly of and next to each pair of high-speed signal contacts, and other signal contacts.

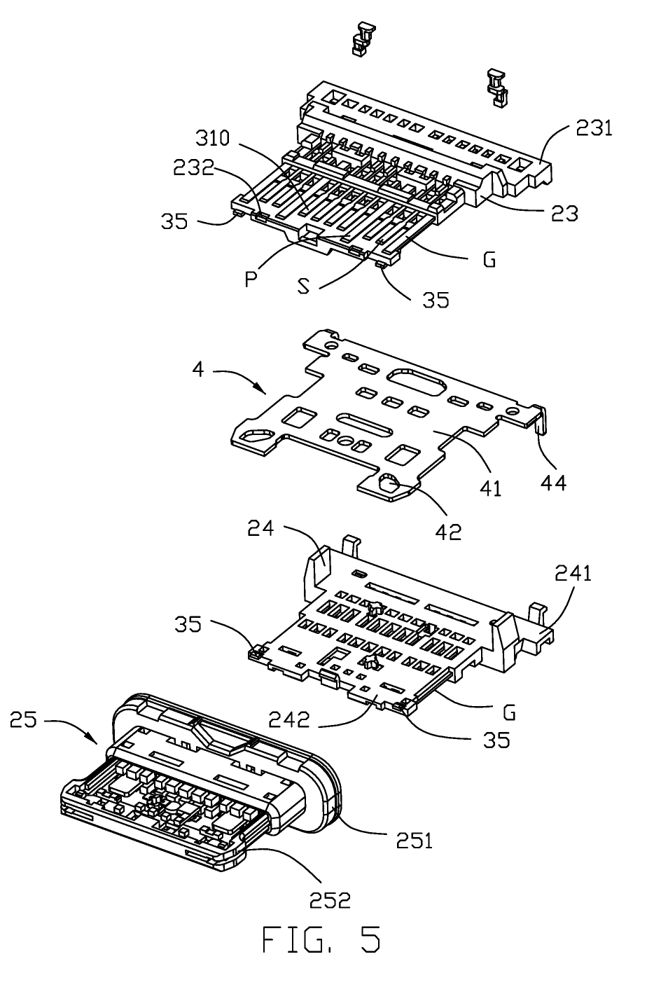

Referring to FIGS. 5-8, the shielding plate 4 includes a main portion 41 and a pair of rear grounding legs. Referring to FIGS. 1-2 and 8, the shielding shell 5 includes an inner shell part 52 and an outer shell part 51.

In the first embodiment, the ground contacts G are located outside associated insulator, extending through corresponding holes 42 on the shielding plate 4, so the extensions 35 thereof in the upper row abut the extensions 35 thereof in the lower row. In particular, the extensions 35 of the upper ground contacts G are applied with material tin (Sn) and this material Sn would melt during over-molding the over-mold 25 so that each upper ground contact G reliably connect to a corresponding lower ground contact G.

The electrical connector 100 is substantially manufactured by the following steps: forming an upper row of contacts and a lower row of contacts, each row of contacts including a ground contact having a front extension; preparing an upper contact module unit and a lower contact module unit, the upper contact module unit including the upper row of contacts and the lower contact module unit including the lower row of contacts; applying material tin (Sn) to at least one of the front extensions of the upper and ground contact and the lower ground contact after the forming step or the preparing step; securing the upper contact module unit to the lower contact module unit with the material Sn being situated between the front extensions of the upper ground contact and the lower ground contact; and molding an insulator over the secured upper and lower contact module units while melting the material Sn to be connected between the extension of the upper ground contact and the extension of the lower ground contact.

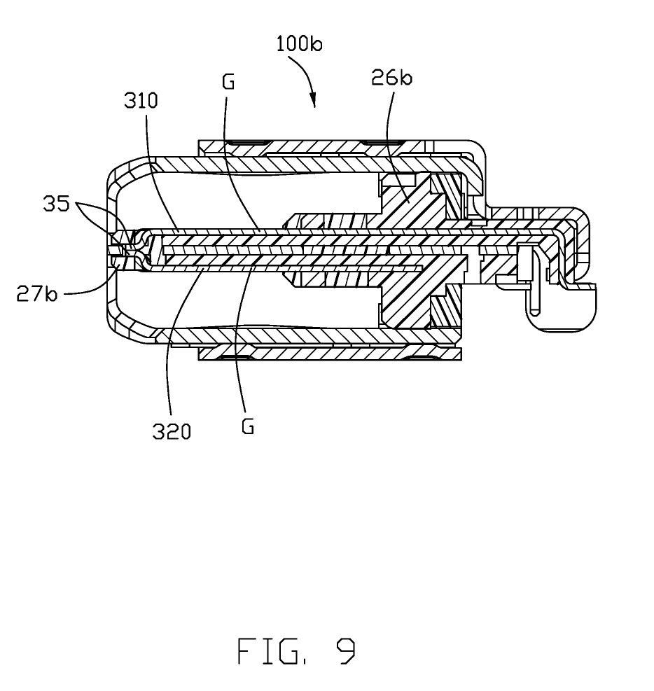

FIG. 9 shows an electrical connector 100b of a second embodiment which differs from the first embodiment in that corresponding upper and lower rows of contacts and middle shielding plate are insert molded with an insulator 26b and then an insulator 27b is over-molded. Corresponding extensions 35 are located outside the insulator 26 and then are embedded in the over-molded insulator 27b.

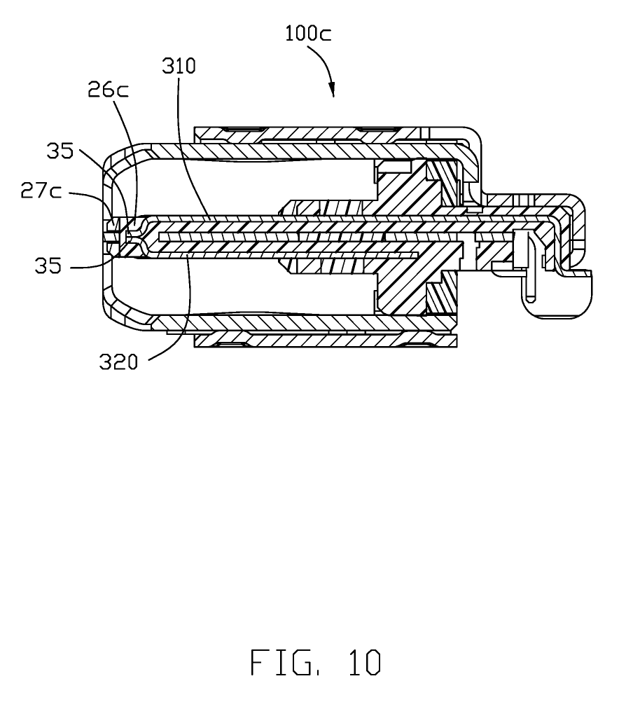

FIG. 10 shows an electrical connector 100c of a third embodiment which differs from the second embodiment in that corresponding extensions 35 of upper and lower ground contacts G are already embedded in an insulator 26c before over-molding an insulator 27c.

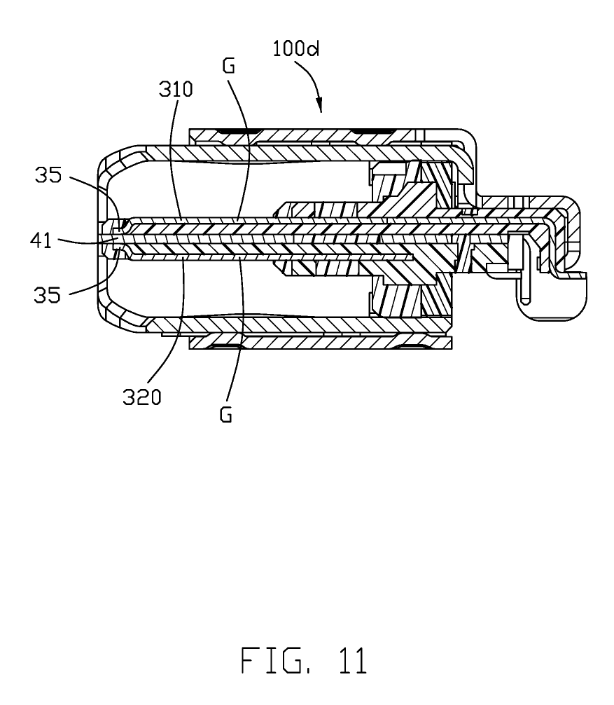

FIG. 11 shows an electrical connector 100d of a fourth embodiment. In the electrical connector 100d, corresponding extensions 35 of upper ground contacts G and lower ground contacts G are applied with material Sn and abut corresponding middle shielding plate 4 instead. This material Sn would melt during over-molding so that each ground contact G reliably connects to the middle shielding plate 4.

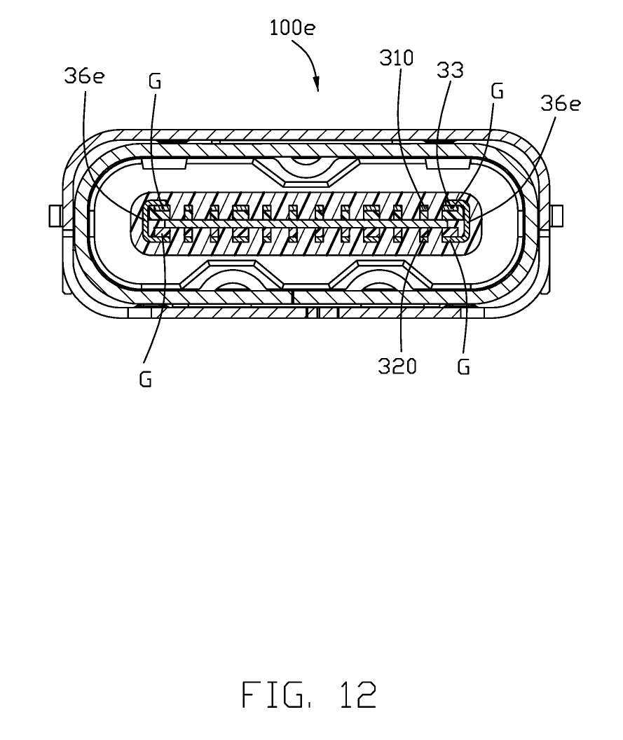

FIG. 12 shows an electrical connector 100e of a fifth embodiment. In the electrical connector 100e, corresponding main portion 33 of ground contact 310 or 320 in one row has a side extension 36e which is applied with material tin (Sn) and is to engage a corresponding ground contact G in the other row. This material Sn would melt during over-molding so that the ground contacts G in upper and lower rows reliably connect to each other.

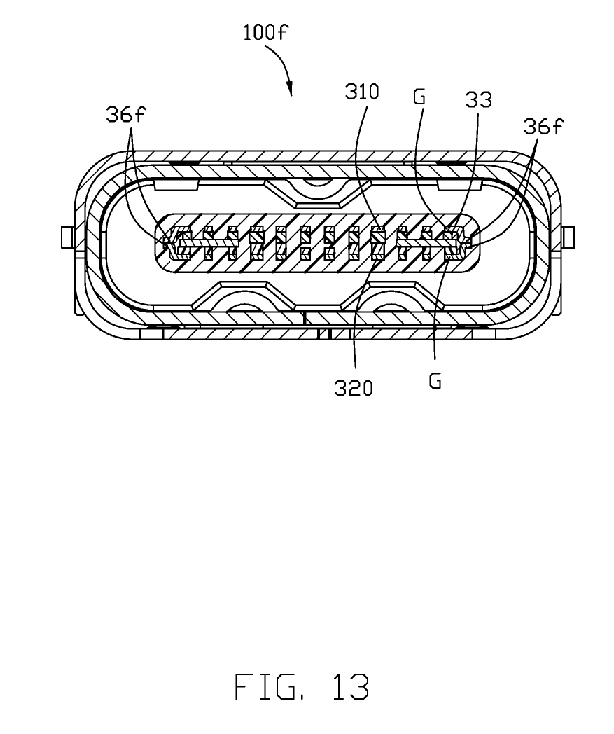

FIG. 13 shows an electrical connector 100f of a sixth embodiment which differs from the fifth embodiment in that corresponding main portion 33 of each ground contact in both upper and lower rows has a respective side extension 36f. The side extensions 36f of upper and lower ground contacts G engage and soldered to each other during over-molding.

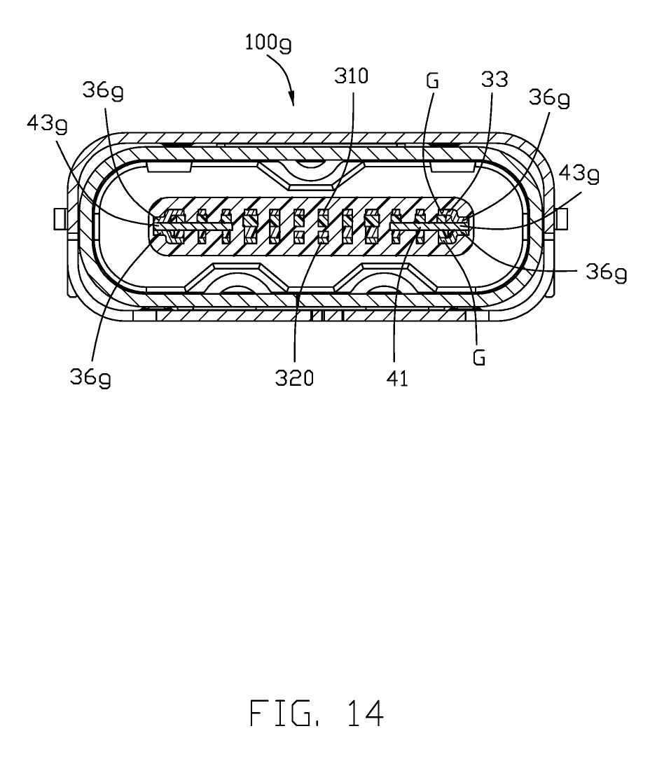

FIG. 14 shows an electrical connector 100g of a seventh embodiment. In the electrical connector 100g, corresponding side extensions 36g of upper ground contacts G and lower ground contacts G are applied with material Sn and abut corresponding middle shielding plate 4 instead. This material Sn would melt during over-molding so that each ground contact G reliably connects to the middle shielding plate 4.

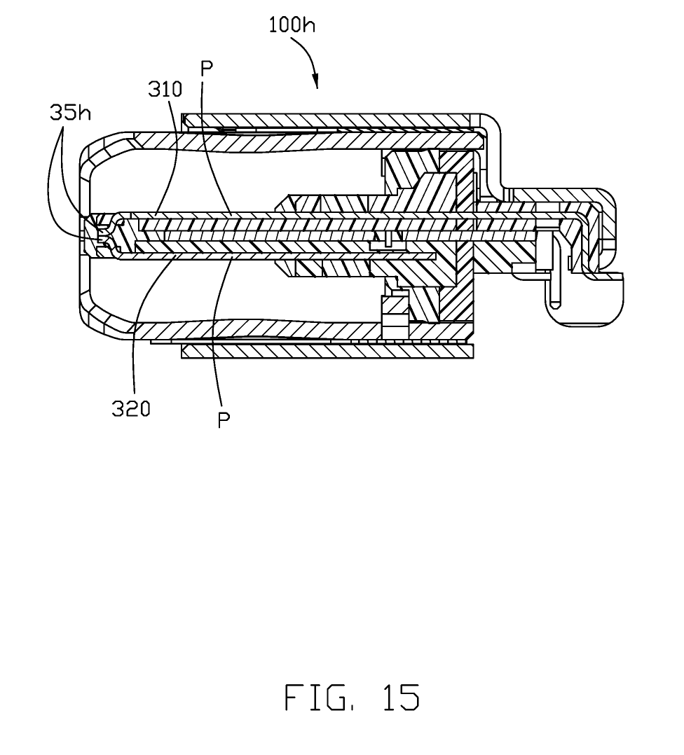

FIG. 15 shows an electrical connector 100h of an eighth embodiment. In the electrical connector 100h, corresponding front extensions 35h of upper or lower (or both) power contacts P are applied with material tin (Sn) and this material Sn would melt during subsequent over-molding process so that abutting extensions of the upper and lower power contacts P reliably connect to each other.

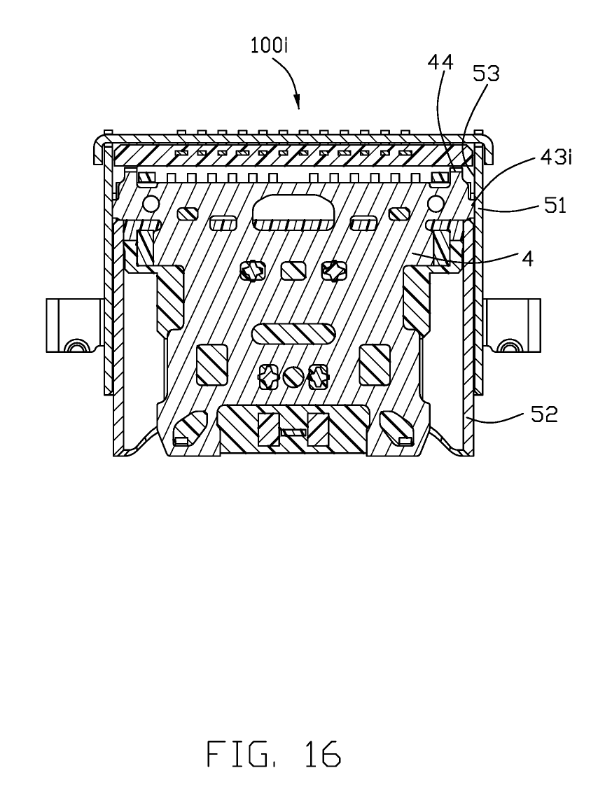

FIG. 16 shows an electrical connector 100i of a ninth embodiment. In the electrical connector 100i, main portion 41 of corresponding shielding plate 4 extends outside of corresponding housing 2 to abut corresponding shielding shell 5. The main portion 41 has extensions 43i applied with material tin (Sn) and this material Sn would melt during surface mounting (SMT process) the connector to a printed circuit board. The material Sn would solidify after the surface mounting process and stably connects the shielding plate 4 and the shielding shell 5.

Application of material tin (Sn) may be made by plating or gluing or the like operations. In the case of contacts abutting shielding plates, material Sn may be applied to the shielding plate rather than the contact, or even be applied to both.

What is claimed is:

1. An electrical connector comprising:
an insulative housing having a base and a tongue; and
an upper and a lower rows of contacts secured to the insulative housing and exposed respectively to an upper and a lower faces of the tongue, each row of contacts including a ground contact, each of the ground contact in the upper row and the ground contact in the lower row having an extension; and
a metallic middle shielding plate located between the upper rows of contacts and the lower row of contacts; wherein
at least one of the extensions of the upper ground contact and the lower ground contact is applied with material tin (Sn), and said tin will be sequentially melted and solidified during an over-molding process forming an outer part of the housing for either connecting the upper ground contact and lower ground contact together or connecting said at least one of the upper ground contact and the lower ground contact with the middle shielding plate together.

2. The electrical connector as claimed in claim 1, wherein said material Sn is connected between the extension of the upper ground contact and the extension of the lower ground contact.

3. The electrical connector as claimed in claim 2, wherein the extension is formed at a front end of the ground contact.

4. A method of making an electrical connector, comprising the steps of:
forming an upper row of contacts and a lower row of contacts, each row of contacts including a ground contact having an extension;
preparing an upper contact module unit and a lower contact module unit, the upper contact module unit including the upper row of contacts and the lower contact module unit including the lower row of contacts;
applying material tin (Sn) to at least one of the extensions of the upper ground contact and the lower ground contact after the forming step or the preparing step;
securing the upper contact module unit to the lower contact module unit with the material Sn being situated between the extensions of the upper ground contact and the lower ground contact; and
molding an insulator over the secured upper and lower contact module units while melting the material Sn to be connected between the extension of the upper ground contact and the extension of the lower ground contact.

5. The method as claimed in claim 4, wherein said the extension is located at a front end region of the ground contact.

6. A method of making an electrical connector, comprising the steps of:
forming an upper row of contacts and a lower row of contacts, each row of contacts including a ground contact having an extension;
preparing an upper contact module unit, a middle shielding plate, and a lower contact module unit, the upper contact module unit including the upper row of contacts and the lower contact module unit including the lower row of contacts;
applying material tin (Sn) to at least one of the extensions of the upper ground contact and the lower ground contact after the forming step or the preparing step;
securing the upper contact module unit, the middle shielding plate, and the lower contact module unit together with the material Sn being situated between the at least one extension and the shielding plate; and
molding an insulator over the secured shielding plate and upper and lower contact module units while melting the material Sn to be connected between the at least one extension and the middle shielding plate.

7. The method as claimed in claim 6, wherein the extension is located at a front end region of the ground contact.
